(19) United States
(12) Patent Application Publication
(10) Pub. No.: US 2008/0105444 A1
(43) Pub. Date: May 8, 2008

(54) Hand-Held Foot Activated Extractor

(76) Inventor: Andre Lafleur, Boucherville (CA)

Correspondence Address: CHOATE, HALL & STEWART LLP, TWO INTERNATIONAL PLACE, BOSTON, MA, 02110, US

(21) Appl. No.: 11/779,519

(22) Filed: Jul. 18, 2007

(30) Foreign Application Priority Data
Nov. 6, 2006 (CA) 2566528

(51) Int. Cl. A01B 45/02

(52) U.S. Cl. 172/22

(57) ABSTRACT

Disclosed is a hand-held foot activated extractor useful for removing weed or turf aeration. The extractor comprises a stick with a top handle and an extractor assembly at the bottom which comprises a hollow tine defining i) a distal hollow frustoconical cutter portion defining a circular inlet provided with a cutting edge and a larger diameter outlet, ii) a hollow intermediate portion defining an arcuate wall extending longitudinally from the outlet of the cutter portion, an elongated opening facing the wall and a deflector sloping between the wall and the elongated opening, and iii) a proximal stick connecting portion. The extractor assembly also comprises a step projecting from the stick connecting portion. In use, a material forced at the inlet of the cutter portion loses frictional contact therein as it reaches the outlet, and is directed by the deflector from the outlet toward the opening for ejection of the material.

### FIELD OF THE INVENTION

The present invention relates to hand tools dedicated to weed removal and turf aeration. More specifically, the present invention is directed to a hand-held and foot activated extractor providing automatic side ejection of turf or weed root plug.

### BACKGROUND OF THE INVENTION

Besides powered lawn aerators, some types manually operated turf aerators and weed extractors already known in the prior art and available on the market. Most types either perform lawn aeration or weed extraction and require manual actuation of a lever or piston to eject the plug of weed roots or soil at the end of each extraction cycle. Such manual tools for the removal of plugs from the ground are disclosed in US patents such as U.S. Pat. No. 4,819,735 (Puckett), U.S. Pat. No. 5,338,078 (Basek) and U.S. Pat. No. 5,469,923 (Visser). Of course, manually operating a piston or like device for ejecting the plug after every cycle is tedious, requiring more time and energy to complete a weed extraction or an aeration job.

Some manual lawn aeration tools do not require plug removal since holes are created by forcing solid prongs into the ground as taught in U.S. Pat. No. 5,813,471 (Ramsey). However, it is well known that such a process creates holes by compacting the soil around it since no material is actually removed from the ground. Therefore, overall lawn compaction and soil hardness are not efficiently treated through such a technique, and holes tend to return to a closed status more rapidly. Also, such tools can obviously not be used for weed removal.

The prior art teaches a few examples of hand-held and foot activated weed removal tools that can be used as well for aerating small lawn areas, and that are claimed to provide easy expulsion of the plug. U.S. Pat. No. 6,330,921 (Barber) and US patent application No. 2003/0037715 (Santa Cruz et al.) discloses such tools. Barber teaches a tool wherein a short annular cutting blade is connected to a retainer at a distal end of an elongate handle-attachment assembly. The connection provides an axial gap between the annular blade and the retainer, the gap being open towards opposite sides of the attachment to facilitate removal of earth plugs cut by the annular blade. In the Santa Cruz application, the efficient end of the elongated tool in made from typical tubular metal stock provided with an elongate side opening for weed expulsion. From experience, it can be stated that such concepts do not provide efficient expulsion of the plug, which tends to remain jammed in the cutting means or be pushed and compressed against the portion of the tube or retainer above the ejection opening when introducing a next plug into the tool, without first removing the previous one. Both situations necessitate some manual intervention from the user to clear the tool.

It would therefore be a significant advance in the art of plug extracting tool, for weed removal or lawn aeration, to provide a hand-held foot powered extractor featuring self-clearing by auto-ejection of the previously cut plug every time a new plug is pushed in at the cutting end.

### SUMMARY OF THE INVENTION

It is an object of the present invention to provide a hand-held foot activated extractor for weed removal or lawn aeration which obviates the limitations and drawbacks of the prior art tools, namely by featuring optimal cutter configuration and plug auto-ejection.

More specifically, in accordance with the present invention, there is provided a hand-held foot activated extractor comprising a stick having a first end with a handle and a second end with an extractor assembly. The extractor assembly comprises a hollow tine defining i) a distal hollow frustoconical cutter portion defining a circular inlet provided with a cutting edge and a larger diameter outlet, ii) a hollow intermediate portion defining an arcuate wall extending longitudinally from the outlet of the distal hollow frustoconical cutter portion, an elongated opening facing the arcuate wall and an elongated deflector sloping between the arcuate wall and the elongated opening, and iii) a proximal stick connecting portion. The extractor assembly is also provided with a step projecting perpendicularly from the proximal stick connecting portion. In use, a material forced at the inlet of the frustoconical cutter portion loses frictional contact therein as it reaches the outlet thereof, and is directed by the deflector from the outlet toward the opening for ejection of the material from the extractor assembly.

The present invention also relates to the use of a hand-held foot activated extractor according to the invention for removing weed roots or turf.

The present invention further provides a method of use of a hand-held foot activated extractor according to invention. The method comprises the following steps:
a) gripping the extractor handle with one hand and the extractor stick with another hand to position the cutter edge on a turf area to be punched for extraction of a plug containing a weed with roots or a healthy turf for aeration,
b) placing a foot on the step of the extractor assembly,
c) applying a substantially vertical force therewith to insert the cutter into the ground,
d) lifting the foot and pulling back with the hands the extractor containing the extracted plug into the cutter, thereby leaving a neat hole into the ground, and
e) repeating steps a) to d) so as the plug extracted into step d) is pushed further downstream into the hollow tine by a next plug being forced into the inlet during step d).

Other features and advantages of the present invention will be better understood upon reading the following non restrictive description made with reference to the appended drawings.

### BRIEF DESCRIPTION OF THE DRAWINGS

FIG. 1a is a perspective view of a hand-held foot activated extractor according to a preferred embodiment of the present invention;

FIG. 1b is a front elevational view of the extractor of FIG. 1a;

FIG. 1c is a side elevational view of the extractor of FIG. 1a;

FIG. 1d is an exploded view of the extractor of FIG. 1a;

FIG. 2a is as perspective view of an extractor assembly of the extractor of FIG. 1;

FIG. 2b is a front elevational view extractor assembly of FIG. 2a;

FIG. 2c is a side elevational view of extractor assembly of FIG. 2a;

FIG. 2d is a top plan view of the extractor assembly of FIG. 2a;

FIG. 3a is a perspective view of a hollow tine of the extractor assembly of FIG. 2;

FIG. 3b is a front elevational view of the hollow tine of FIG. 3a;

FIG. 3c is a side elevational view of tan hollow tine of FIG. 3a;

FIG. 3d is a plan view of the hollow tine of FIG. 3a;

FIG. 3e is cross sectional view of the hollow tine of FIG. 3a, taken along line E-E of FIG. 3d;

FIG. 4a is a perspective view of a step of the extractor assembly of FIG. 2;

FIG. 4b is a top plan view the step of FIG. 4a;

FIG. 4c is a side elevational view of the step of FIG. 4a;

FIG. 4d is front elevational view of the step of FIG. 4a;

FIG. 5 shows a side cross sectional elevation of a hollow tine according to an alternate embodiment of the extractor of the present invention.

### DETAILED DESCRIPTION OF THE INVENTION

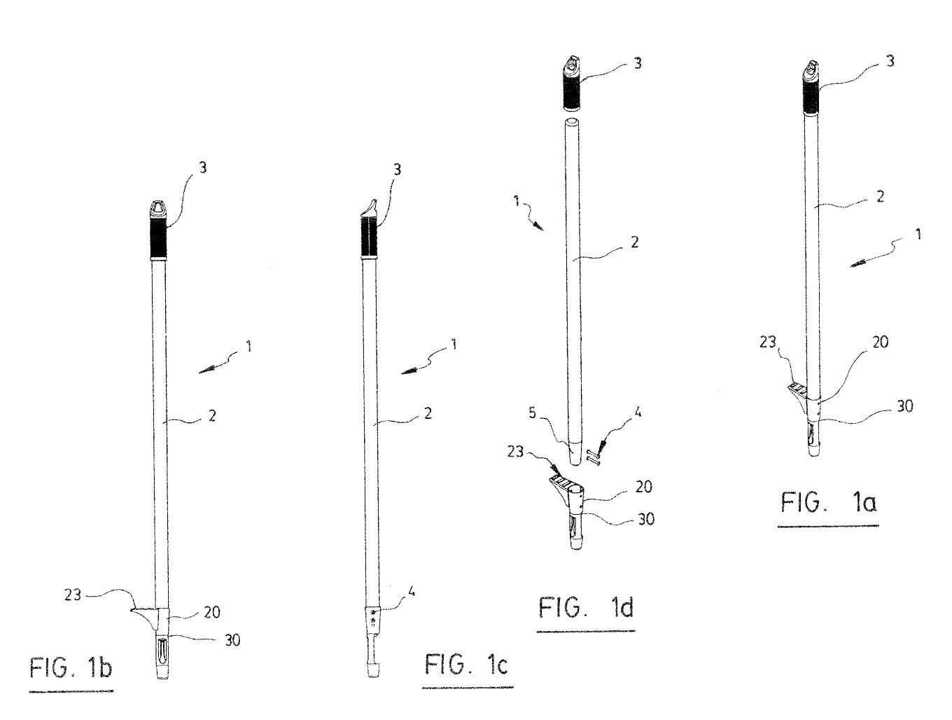

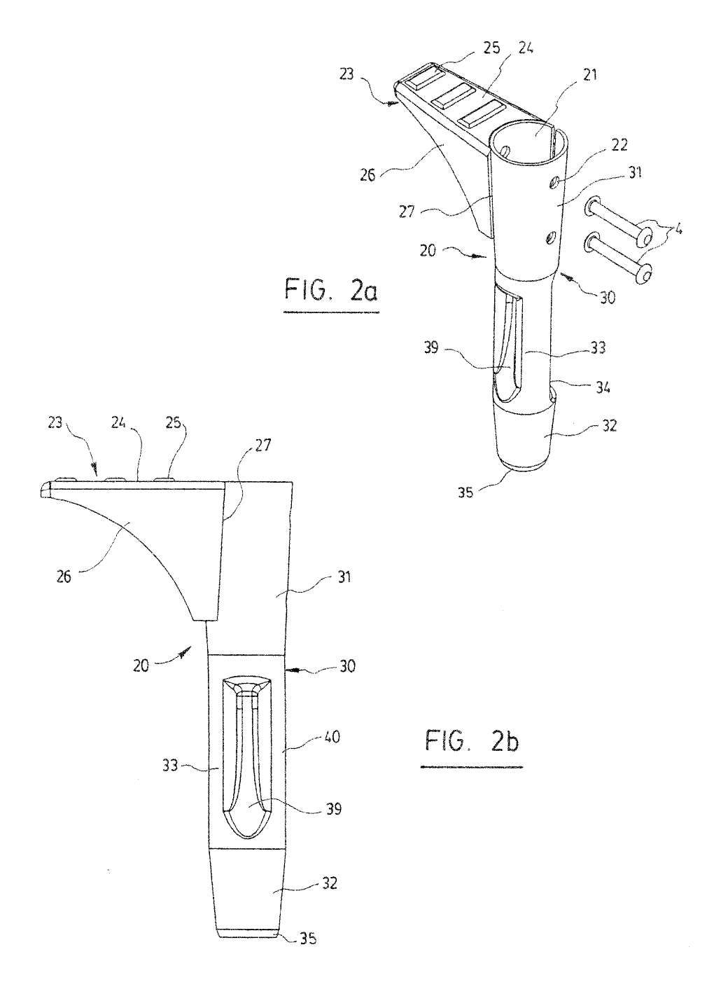

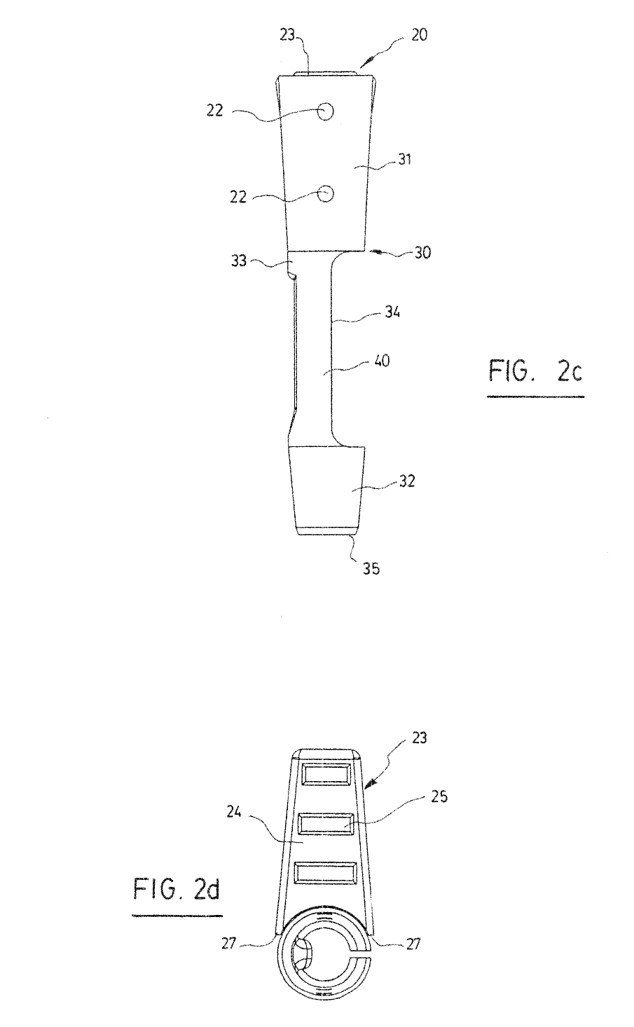

FIGS. 1a to 1d show different views of a hand-held foot activated extractor 1 according to the present invention. Extractor 1 mainly comprises a stick 2 to which a handle 3 is mounted at a proximal end thereof and an extractor assembly 20 assembled at a distal end thereof using a pair of rivets 4. Stick 2 is preferably made from wood, a rigid, light and cheap material often used in outdoor tools, while handle 3 can be injection molded from an elastomer material to provide an efficient grip and enable easy press fit onto the wood stick 2. Thereby, extractor 1 can be firmly held by a user, using both hands. The extractor assembly 20, best seen from FIGS. 2a to 2d, has a tapering receptacle 21 to receive the frustum portion 5 at the distal end of stick 2. Assembly 20 is assembled to stick 2 by mounting rivets 4 through holes 22 registering with drilled holes (not shown) in frustum 5.

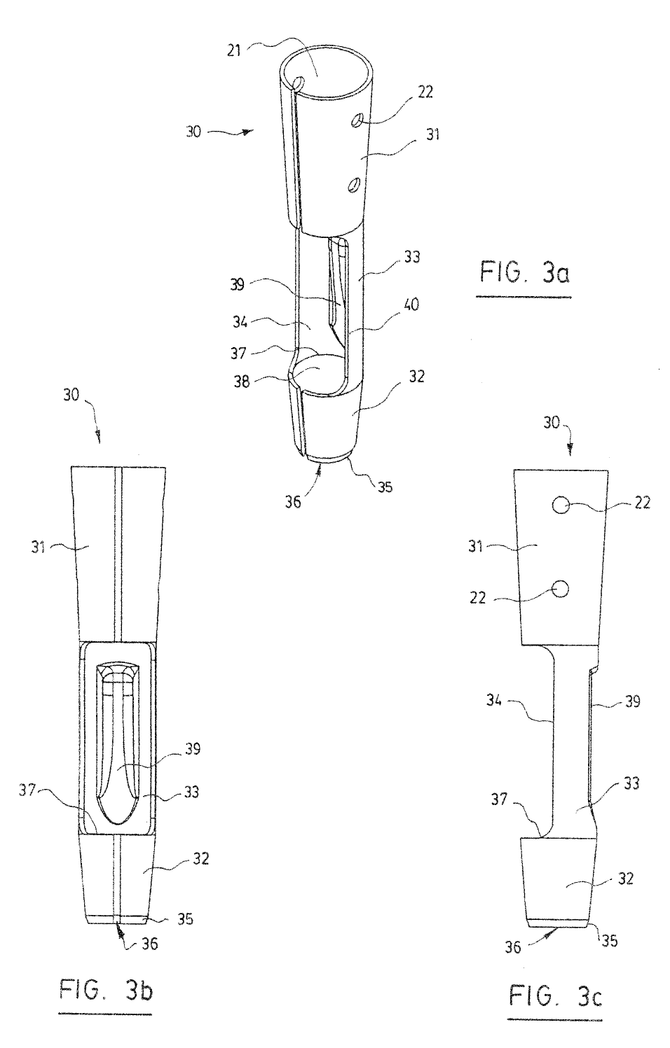

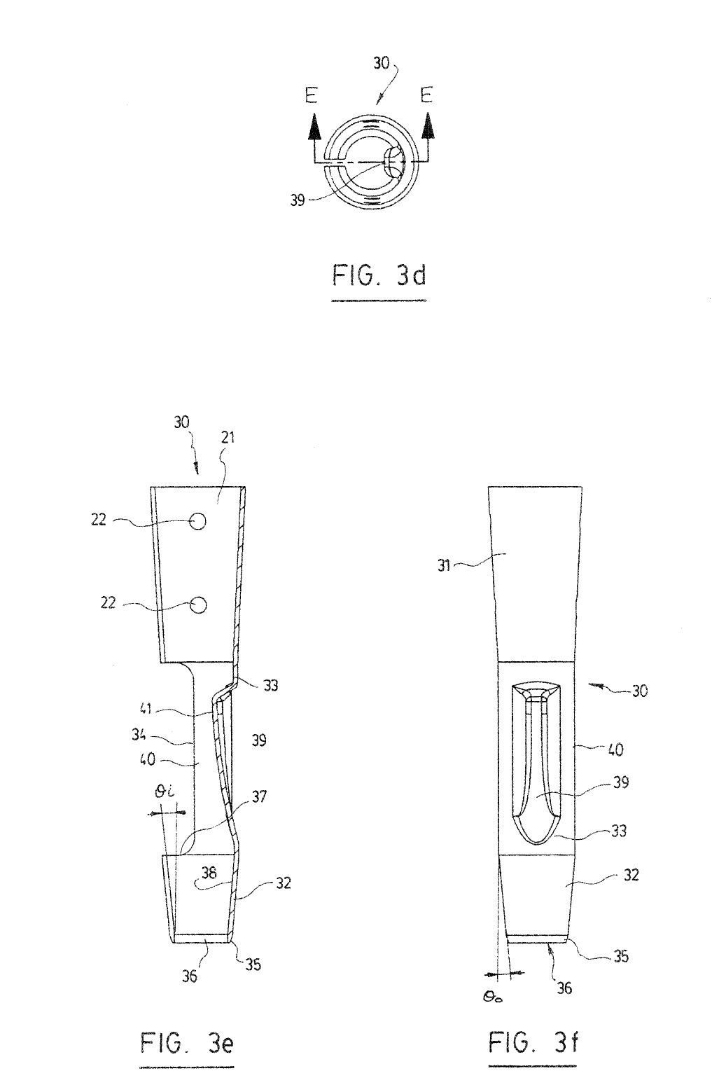

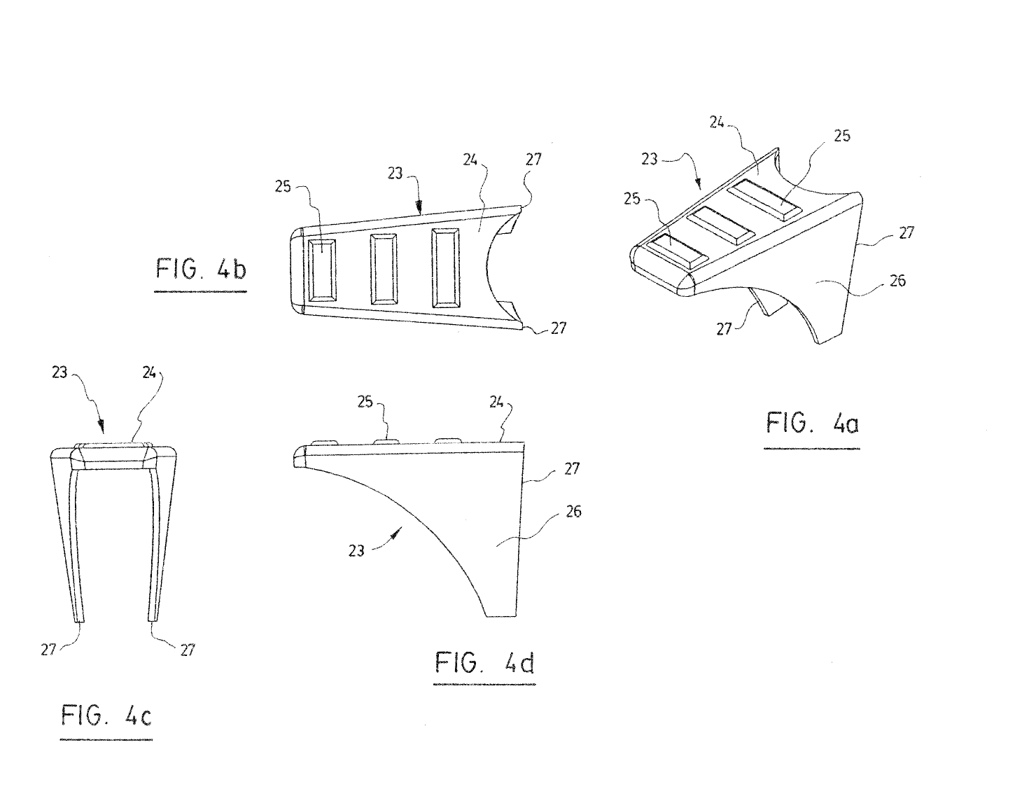

As shown in the different views of FIGS. 2a to 2d, assembly 20 comprises a step 23 and a hollow tine 30. Hollow tine 30 is preferably formed from a single piece of sheet metal. Advantageously, step 23 and tine 30 (see FIGS. 3a to 3e for details) are both preferably made from strong wear and weather resistant material such as galvanized or stainless steel (or steel painted after forming), die cut and folded from sheet form. Step 23 (see FIGS. 4a to 4d) comprises a foot engaging surface 24 provided with anti-slip ridges 25, and side panels 26 welded to the outer surface of the receptacle end 31 of tine 30 at their straight edges 27 to ensure a strong and stable assembly of step 23. The foot engaging surface 24 extends substantially orthogonal to the longitudinal axis of stick 2 and tine 30, so that a user can conveniently push the step with a foot to help driving the tine into the ground.

Tine 30, best viewed from FIGS. 3a to 3e, comprises three principal portions. The proximal stick mounting frustoconical receptacle portion 31 with holes 22 as described above, a distal frustoconical cutter portion 32 and an intermediate portion comprising an embossed arcuate wall 33 and an elongated opening 34.

The cutter portion 32 defines a circular cutting edge 35 bordering a circular inlet 36. The frustoconical cutter 32 also defines an outlet 37 of larger inner diameter than inlet 36. The tapering angle defined by the inner frustoconical surface of the cutter portion tapering in the direction of the cutting edge should be from 1 to 10 degrees, with a preferred value of 5 degrees. This important feature is meant to ensure that the cut material, forming a plug having a diameter substantially equal to that of cutting edge 35, forced into inlet 36 gradually loses friction with the inner peripheral wall 38 as it moves toward cutter outlet 37. Thereby, the plug becomes substantially loose and easy to transport toward opening 34 for ejection. This feature also ensures that minimal pressure is required to force a next plug into inlet 36 still containing the previous plug that must be pushed further downstream by said next plug being cut, but still enough pressure, which combined with the length of the cutter 32, provide sufficient friction to pull out the plug from the ground. In order to enable the extractor to be usable effectively for weed removal as well as for turf aeration, the inlet diameter is preferably selected to be between 1.5 and 3 cm, with a preferred value of about 2 cm. Also, the length of the elongated opening 34 is advantageously selected to be between 2 and 6 cm.

According to a preferred embodiment, the cutter portion 32 defines a peripheral wall 38 of generally uniform thickness extending between the cutting edge 35 and the outlet 37.

Since the cutter is advantageously made from uniform thickness sheet material for ease of production and low cost, the outer shape of the cutter portion 32 is generally identical to its inner shape, with slightly larger dimensions. The conical shape added to the effect of thickness tends to create ground compression around the hole and increase the force required to drive the cutter into the ground. To limit these side effects to an acceptable extent, wall thickness is minimized to about 1.6 mm to provide sufficient structural force, and a tapering angle below or equal to 10 degrees also provides good results. In other words, this means that the cutter portion defines an outer frustoconical surface tapering in the direction of the cutting edge with an angle of 0 to 10 degrees. However, an outer tapering angle is not necessary for adequate performance of the extractor 1; therefore an alternate embodiment with a straight cylindrical outer surface of the cutter portion 32 can be contemplated, as long as the inner configuration still provides a tapering angle to promote easy plug ejection. The inventor although considers this embodiment as generally less cost effective to produce.

The height of the cutter portion 32, from the cutting edge 35 to the outlet 37 is another factor governing adequate performance of the extractor 1. It must be long enough to effectively retain the plug into the cutter by friction so to pull it out from the ground, leaving a clear hole, but not too long to produce excessive friction with the soil and peripheral ground material surrounding the hole so to prevent the same from being pulled out, thus forming ribbed craters and damaging the ground surface. Therefore, the length of the cutter portion from the cutting edge to the outlet is preferably larger than the diameter of the cutting edge with a ratio between 1.1 and 1.5. A ratio of the cutter height to inlet diameter of about 1.5 has been found to allow optimal performance in the preferred embodiment featuring a thin wall frustoconical cutter portion as described heretofore.

It is also worth mentioning that while a circular geometry of the cutter portion 32 has been described so far, equivalent functions and performance would be obtainable from a cutter having a substantially different cross section. For example, a pyramidal square or triangular cross section cutter can be contemplated. Therefore, the scope of the present invention should be deemed to include all alternative shapes, although the round shape is adequate and more practical for the applications contemplated herein.

The intermediate third portion of the hollow tine 30, connecting the distal cutter portion 32 to the proximal stick mounting receptacle portion 31 will now be described in detail referring to FIGS. 3a to 3e.

The intermediate portion comprises an arcuate U shaped wall 33 provided with a deflector defined by a longitudinal wedge shaped embossment 39 tapering in the direction of the cutter outlet 37. The wall 33 of this intermediate portion comprises an arcuate back portion and two longitudinal non-convergent wing portions 40 extending from each side of the arcuate portion and being tangent to this arcuate portion and forming longitudinal edges of the elongated opening 34.

The wall 33 covers about half of the periphery of the intermediate portion, while the opposite second half defines the elongated opening 34 having a length substantially equal to that of the wall 33. The opening 34 serves as an exit for ejection of extracted plugs out of the extractor 1. Therefore, lateral sides of wall 33 defining the pair of straight non-converging wings 40 extending slightly beyond the centre axis of tine 30 render the hollow intermediate portion stronger and help to properly guide extracted plugs toward the opening 34 without causing any restriction. To ensure proper deviation of plugs toward opening 34, the higher relief portion near the downstream end of the longitudinal wedge shaped embossed deflector 39 projects from the inner surface of wall 33 to a distance approximately equal to half the diameter of the cutting edge 35.

In operation, a user holds the extractor 1 by gripping handle 3 and stick 2 with two hands to position the cutter edge on a turf area to be punched for extraction of a plug containing the roots of a weed or a healthy turf for aeration. The large opening 34 may serve as a window to help the user to accurately position the cutter in the case of weed removal. The user then places a foot on surface 24 of step 23 and applies a substantially vertical force therewith to drive the cutter into the ground, preferably to a depth of about 5 to 8 cm, and then lifts the foot and pulls back the extractor with the hands. A plug is extracted and remains into the cutter leaving a neat hole into the ground. Repeating the process causes the first plug to be pushed further upstream into the hollow tine by the next plug being forced into inlet during the insertion phase. Depending on the depth of insertion, the first plug will typically be ejected through the opening 34 each time a next plug enters completely into the tine. Embossment 39 sloping in the direction of the opening 34 ensures that a plug entering the intermediate portion of the hollow tine 30 is deviated toward the opening and exits the extractor instead of naturally hitting the bottom of the distal end of stick 2 causing rapid clogging of the tine.

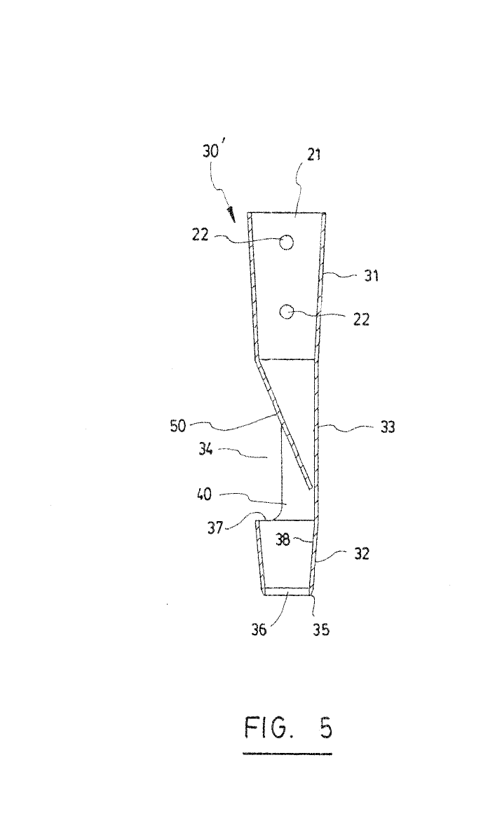

It should be noted that the deflector 39, formed by a longitudinal wedge shaped embossment in wall 33 according to the embodiment described heretofore, could be implemented differently for substantially equivalent results. The basic principle must remain to provide a sloping member along a path originating from the intersection of wall 33 and outlet 37 and crossing the center axis of the tine. In other words, the deflector 39 is preferably defined by a sloping member extending from a proximal end of the opening 34 and sloping inwardly into the hollow tine toward an intersection between the wall 33 and the outlet 37. For example, a tab 50 (see FIG. 5) extending from the base of the receptacle portion 31 above opening 34 into the direction of the lower portion of wall 33 could be provided. Such a tab could be formed from material removed to create opening 34.

One can thus easily appreciate that the above described embodiments of the hand-held foot activated extractor according to the present invention obviate the limitations and drawbacks of the prior art devices, namely by providing reliable and neat extraction as well as automatic ejection of the plugs. Therefore, it can be seen that the extractor can be advantageously used for removing weeds or performing small elongated holes into a ground for aeration or any other purpose.

Although the present invention has been described hereinabove by way of preferred embodiments thereof, it can be modified, without departing from the spirit and nature of the subject invention as defined in the appended claims.

1- A hand-held foot activated extractor comprising a stick having a first end with a handle and a second end with an extractor assembly, said extractor assembly comprising:
a) a hollow tine defining:
a distal hollow frustoconical cutter portion defining a circular inlet provided with a cutting edge and a larger diameter outlet,
a hollow intermediate portion defining an arcuate wall extending longitudinally from the outlet of the distal hollow frustoconical cutter portion, an elongated opening facing the arcuate wall and an elongated deflector sloping between the arcuate wall and the elongated opening, and
a proximal stick connecting portion, and
b) a step projecting perpendicularly from the proximal stick connecting portion,
whereby, in use, a material forced at the inlet of the frustoconical cutter portion loses frictional contact therein as it reaches the outlet thereof, and is directed by the deflector from the outlet toward the opening for ejection of the material from the extractor assembly.

2- The hand-held foot activated extractor of claim 1, wherein the deflector is in the form of a longitudinal wedge shaped embossment provided in the arcuate wall, tapering in the direction of the cutter portion and projecting toward the opening.

3- The hand-held foot activated extractor of claim 2, wherein the embossment defines a portion of higher relief projecting inwardly from the arcuate wall to a distance approximately equal to half the diameter of the cutting edge.

4- The hand-held foot activated extractor of claim 1, wherein the deflector is in the form of a sloping member extending from a proximal end of the opening and sloping inwardly into the hollow tine toward an intersection between the wall and the outlet.

5- The hand-held foot activated extractor of claim 1, wherein the cutter portion has an inner frustoconical surface tapering in the direction of the cutting edge with an angle of 1 to 10 degrees.

6- The hand-held foot activated extractor of claim 1, wherein the cutter portion has an outer frustoconical surface tapering in the direction of the cutting edge with an angle of 0 to 10 degrees.

7- The hand-held foot activated extractor of claim 1, wherein the cutter portion has a peripheral wall of generally uniform thickness extending between the cutting edge and the outlet.

8- The hand-held foot activated extractor of claim 1, wherein the wall of the intermediate portion has a generally U shape profile and comprises an arcuate back portion and two longitudinal non-convergent wing portions extending from each side of the arcuate portion and being tangent to said arcuate portion and forming longitudinal edges of the elongated opening.

9- The hand-held foot activated extractor of claim 1, wherein the length of the cutter portion from the cutting edge to the outlet is larger than the diameter of the cutting edge, with a ratio between 1.1 and 1.5.

10- The hand-held foot activated extractor of claim 9, wherein the diameter of the inlet of the cutter portion is from 1.5 to 3 cm.

11- The hand-held foot activated extractor of claim 1, wherein the length of the elongated opening is between 2 and 6 cm.

12- The hand-held foot activated extractor of claim 1, wherein the hollow tine is formed from a single piece of sheet metal.

13- Use of the hand-held foot activated extractor as defined in claim 1 for removing weed roots or turf.

14- Use of the hand-held foot activated extractor as defined in claim 1 for performing holes into the ground for aeration.

15- A method of use of the hand-held foot activated extractor as defined in any one of claim 1, comprising the following steps:
a) gripping the extractor handle with one hand and the extractor stick with another hand to position the cutter edge on a turf area to be punched for extraction of a plug containing roots of a weed or a healthy turf for aeration,
b) placing a foot on the step of the extractor assembly,
c) applying a substantially vertical force therewith to insert the cutter into the ground,
d) lifting the foot and pulling back with the hands the extractor containing the extracted plug into the cutter, thereby leaving a neat hole into the ground, and
e) repeating steps a) to d) so as the plug extracted into step d) is pushed further downstream into the hollow tine by a next plug being forced into the inlet during step d).

16- The method according to claim 15, characterized in that, in step e), the plug which is pushed upstream into the hollow tine is further ejected through the elongated opening.

17- The method according to claim 15, characterized in that, in step c), the cutter is inserted into the ground to a depth of about 5 to 8 cm.
